(19) United States
(12) Patent Application Publication
(10) Pub. No.: US 2026/0253496 A1
(43) Pub. Date: Aug. 27, 2026

(54) SYSTEM AND METHOD FOR SUPPLEMENTING SENSOR DATA

(71) Applicant: Torc Robotics, Inc., Blacksburg, VA (US)

(72) Inventors: Maximilian Koeper, Ostfidern (DE); Stefan Koch, Pforzheim (DE)

(21) Appl. No.: 19/063,604

(22) Filed: Feb. 26, 2025

(51) Int. Cl. G08G 1/16; B60W 60/00; G08G 1/01; G08G 1/052

(52) U.S. Cl. CPC G08G 1/166; B60W 60/00; G08G 1/0112; G08G 1/052

(57) ABSTRACT

A system for supplementing sensor data for a vehicle is provided. The system includes environment sensors disposed in an environment through which the vehicle navigates to capture a first sensor data set. The system includes vehicle sensors located on the vehicle and configured to capture a second sensor data set. The system includes a processing device that performs operations including acquiring the first sensor data set from the one or more environment sensors, acquiring the second sensor data set from the one or more vehicle sensors, and comparing a matching level of corresponding data between the first and second sensor data sets. If the matching level is determined to be below a matching threshold value due to an inconsistency between the first and second data sets, the operations include replacing or supplementing inconsistent data in the second data set with corresponding data from the first data set.

### TECHNICAL FIELD

The field of the disclosure relates to supplementing vehicle sensor data and, in particular, to a system for supplementing vehicle sensor data with environment sensor data to ensure accurate operation of the vehicle through the environment.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is located. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. These actions undertaken by the vehicle include steering, braking and acceleration.

The perception technologies on the vehicle can include multiple sensors that detect objects in the environment through which the vehicle travels. Although the sensors can sufficiently gather data in an open environment, in certain scenarios, the field-of-view of the sensors may be obstructed or the precision of detection may be reduced. As one example, the trailer associated with the vehicle may obstruct perception of objects behind the trailer due to positioning of the sensors on the vehicle itself. As another example, when traveling through an environment having multiple buildings or objects around the roadway, the vehicle sensors may be incapable of detecting objects around the roadway corner prior to approaching an intersection.

Accordingly, there exists a need for a system and a method of supplementing sensor data on a vehicle to ensure safe passage of the vehicle through an environment. These and other needs are met by the exemplary system for supplementing sensor data discussed herein.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, an exemplary system for supplementing sensor data for a vehicle is provided. The system includes one or more environment sensors disposed in an environment through which the vehicle is configured to navigate. The one or more environment sensors are configured to capture a first sensor data set. The system includes one or more vehicle sensors configured to be located on the vehicle. The one or more vehicle sensors are configured to capture a second sensor data set. The system includes a processing device in communication with the one or more environment sensors and the one or more vehicle sensors. The processing device is configured to execute instructions stored in a memory to perform operations that include acquiring the first sensor data set from the one or more environment sensors. The operations include acquiring the second sensor data set from the one or more vehicle sensors, and comparing a matching level of corresponding data between the first and second sensor data sets. If the matching level is determined to be below a matching threshold value due to an inconsistency between the first and second data sets, the operations include replacing or supplementing inconsistent data in the second data set with corresponding data from the first data set.

In some embodiments, the one or more vehicle sensors and the one or more environment sensors can include at least one of a camera, radar, or LiDAR. In some embodiments, the one or more environment sensors can be different from the one or more vehicle sensors. The one or more environment sensors can have a higher detection accuracy than the one or more vehicle sensors. In some embodiments, the first and second sensor data sets can relate to detected characteristics associated with the vehicle. In some embodiments, the first and second sensor data sets can relate to detected characteristics associated with the environment. In some embodiments, the first and second sensor data sets can relate to detected characteristics associated with both the vehicle and the environment.

In some embodiments, at least a portion of the first sensor data set can include information representative of detected characteristics out of a field-of-view of the one or more vehicle sensors. In some embodiments, at least a portion of the first sensor data set can include information representative of detected characteristics in an obstructed area of a field-of-view of the one or more vehicle sensors. In some embodiments, the detected characteristics can include a moving object, e.g., another vehicle, a pedestrian, or the like.

In some embodiments, the operations can include determining, with the one or more environment sensors, a velocity and trajectory of the moving object. In some embodiments, the operations can include determining if the moving object is on course for a collision with the vehicle. If the moving object is on course for a collision with the vehicle, the operations can include transmitting an alert to the vehicle regarding the moving object.

In some embodiments, the inconsistency can include a lack of matching data between the first and second data sets. In some embodiments, the inconsistency can include a lack of the corresponding data between the first and second data sets. In some embodiments, the one or more environment sensors can be stationary mounted sensors. In some embodiments, the vehicle can be, e.g., an autonomous vehicle, a semi-autonomous vehicle, a non-autonomous vehicle, or the like.

In another aspect, an exemplary computer-implemented method for supplementing sensor data for a vehicle is provided. The method includes acquiring a first sensor data set captured by one or more environment sensors disposed in an environment through which the vehicle is configured to navigate. The method includes acquiring a second sensor data set captured by one or more vehicle sensors configured to be located on the vehicle. The method includes executing instructions stored in a memory with a processing device in communication with the one or more environment sensors and one or more vehicle sensors to perform operations that include comparing a matching level of corresponding data between the first and second sensor data sets. If the matching level is determined to be below a matching threshold value due to an inconsistency between the first and second data sets, the operations include replacing or supplementing inconsistent data in the second data set with corresponding data from the first data set.

In some embodiments, at least a portion of the first sensor data set can include information representative of detected characteristics out of a field-of-view of the one or more vehicle sensors. In some embodiments, at least a portion of the first sensor data set can include information representative of detected characteristics in an obstructed area of a field-of-view of the one or more vehicle sensors. In some embodiments, the operations can include determining, with the one or more environment sensors, a velocity and trajectory of the moving object to determine if the moving object is on course for a collision with the vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic perspective view of an autonomous truck.

FIG. 2 is a schematic perspective view of an autonomous truck and trailer.

FIG. 3 is a schematic side view of an autonomous truck and trailer.

FIG. 4 is a block diagram of the autonomous truck shown in FIGS. 1-3.

FIG. 5 is a block diagram of an example computing system.

FIG. 6 is a block diagram of an exemplary system for supplementing sensor data.

FIG. 7 is a flowchart of a method for supplementing sensor data.

FIG. 8 is an environment including a vehicle with vehicle sensors and environment sensors configured to supplement data captured by the vehicle sensors.

FIG. 9 is a block diagram of an exemplary system for supplementing sensor data, including various inputs of sensor data and outputs generated by sensor fusion.

FIG. 10 is a flowchart of vehicle sensor data and environment sensor data fused to generate a fused object list.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

While highway travel for a vehicle generally includes predictable, highly structured driving scenarios, complex intersections in other environments can result in unpredictable driving operations and unexpected objects in difficult-to-detect areas. As an example, hub locations for vehicles may have multiple buildings that at least partially obstruct the field-of-view of vehicle sensors, and can include multiple moving objects (e.g., other vehicles, pedestrians, cyclists, or the like) that can complicate vehicle operations through the environment.

The exemplary system for supplementing sensor data ensures that accurate sensor data is provided to the vehicle to replace or supplement inconsistent data between vehicle and environment sensors, resulting in a safer operation of the vehicle in the environment. The system includes multiple environment sensors (e.g., static sensors) disposed around the environment, such as at rooftops, corners of buildings, or the like. The environment sensors are configured to monitor the environment and supplement the data captured by vehicle sensors to increase the sensor range for the vehicle.

Due to their positioning in the environment, the environment sensors are able to obtain more accurate data in a larger field-of-view than the vehicle sensors, and can capture data regarding objects outside of the field-of-view of the vehicle sensors (e.g., objects around the corner from the vehicle, objects obstructed by a trailer associated with the vehicle, objects obstructed by other vehicles, or the like). In some embodiments, the environment sensors can have a higher accuracy than the vehicle sensors, and any inconsistency or discrepancy between the environment and vehicle sensor data can be replaced or supplemented with the higher accuracy environment sensor data.

The data captured by each of the environment and vehicle sensors can be compatible (e.g., a shared data format and communication protocols), allowing for smooth communication and fusion of data from both sets of sensors. In some embodiments, the sensor data for both sets of sensors can be the same. In some embodiments, the sensor data for both sets of sensors can be different. For example, the sensors for the vehicle and the environment can include, e.g., cameras, radar, LiDAR, combinations thereof, or the like. By fusing the environment sensor data with the vehicle sensor data, the system significantly improves the vehicle perception range and ensures safe operation of the vehicle through complex environments. The system allows for earlier detection of objects for the vehicle to adapt vehicle operations, and can provide more accurate tracking of the vehicle and the environment.

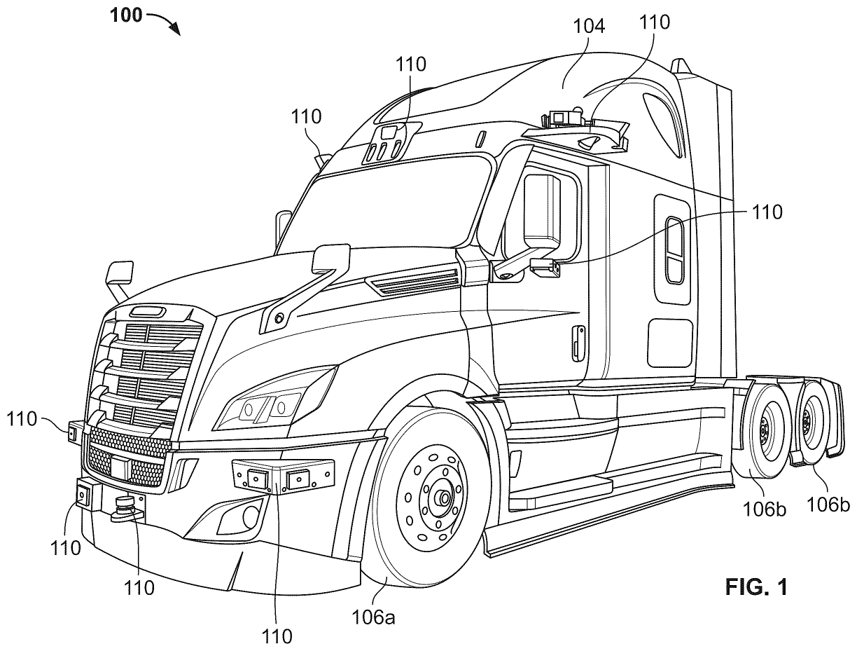

Various embodiments in the present disclosure are described with reference to FIGS. 1-10 below.

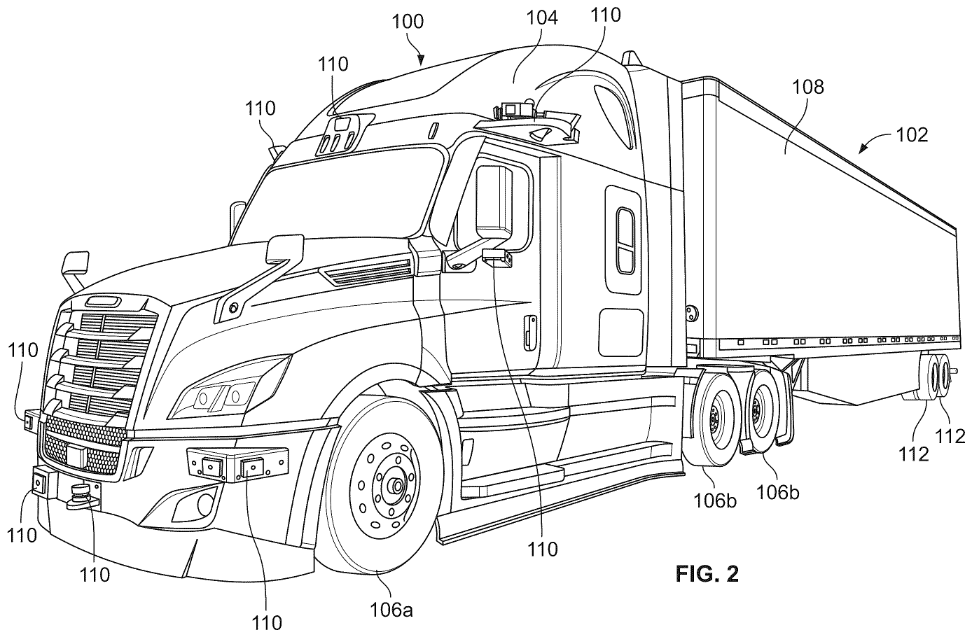

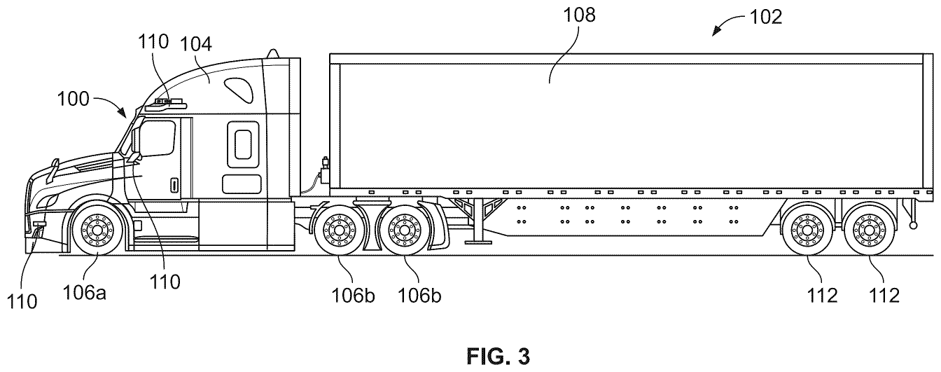

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. The vehicle 100 includes a cabin 104 that can be supported, and steered in the required direction, by front wheels 106a and rear wheels 106b that are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releasably attached. The trailer 102 can include a storage container 108 and a plurality of rear wheels 112 that support the storage container 108. It should be understood that in some embodiments the vehicle 100 and the trailer 102 can be a permanently attached as a single unit.

The sensors 110 have a field-of-view at the front, sides and/or rear of the vehicle 100. Similar sensors 110 can be used around the perimeter of the vehicle 100 to ensure full environmental coverage around the vehicle 100 is provided by the sensors 110. In some embodiments, the vehicle 100 can include, e.g., 5-6 LIDAR sensors, 8-10 cameras, combinations thereof, or the like. In some embodiments, the vehicle 100 can tow a trailer 102 and the trailer 102 can similarly include LIDAR sensors and/or cameras to provide field-of-view coverage around the perimeter of the vehicle 100 and the trailer 102. The environmental coverage by the sensors and/or cameras therefore provides data corresponding with the front, rear, sides and corners of the vehicle 100 and the trailer 102 hauled by the vehicle 100.

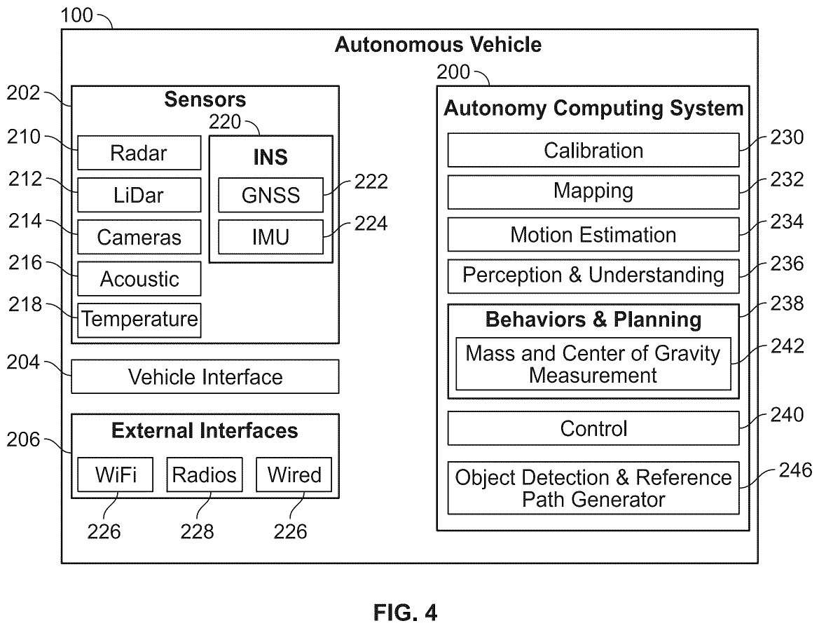

FIG. 4 is a block diagram representing autonomous vehicle 100 shown in FIGS. 1-3. In the example embodiment, autonomous vehicle 100 generally includes autonomy computing system 200, sensors 202, a vehicle interface 204, and external interfaces 206. It should be understood that the sensors 110 on the vehicle 100 in FIGS. 1-3 and described herein correspond to the sensors identified as 202 in FIG. 4. The sensors 110 may specifically comprise any of the sensors 210-220 shown in FIG. 4 and described herein.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying objects around the vehicle 100, updating a reference path based on the detected objects, and controlling operation of the vehicle 100 to guide the vehicle 100 along its route.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100. In some embodiments, the trailer associated with the vehicle 100 can include similar sensors 202 for gathering similar data associated with the trailer, thereby further assisting with control operations of the autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 226, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a mass and center of gravity measurement module 242, a control module or controller 240, and an object detection and reference path generator module 246. The object detection and reference path generator module 246, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

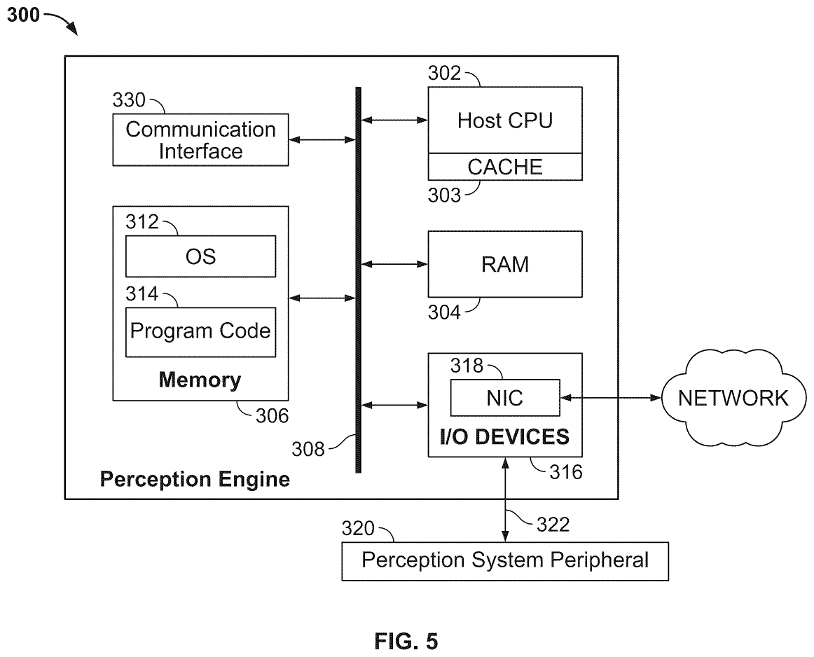

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

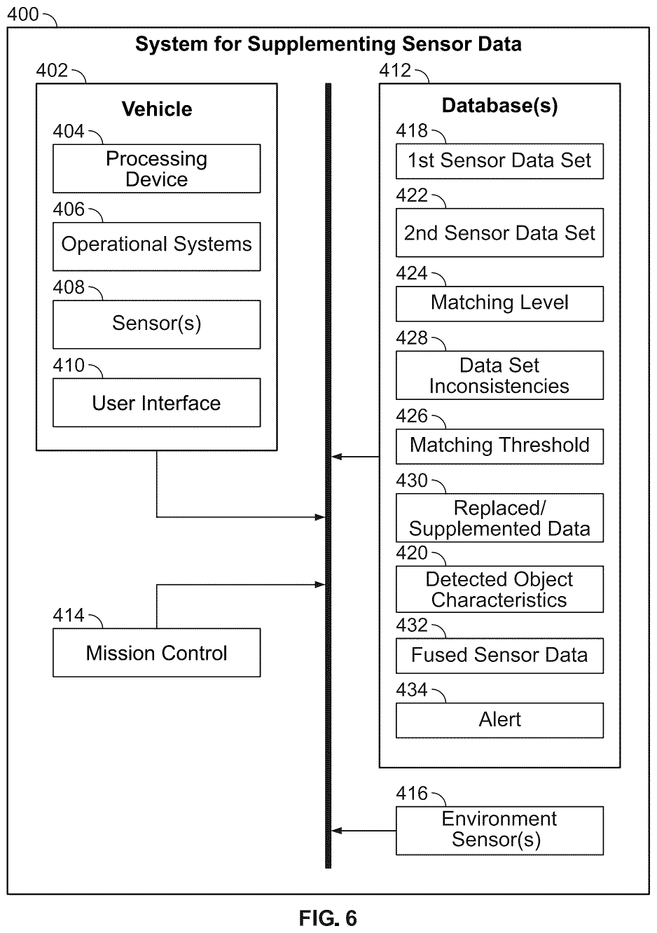

FIG. 6 is a block diagram of an exemplary system 400 for supplementing sensor data for a vehicle. The system 400 generally includes one or more vehicles 402 (e.g., autonomous vehicle 100, semi-autonomous vehicle, and/or non-autonomous vehicle). The vehicle 402 includes a processing device 404 (e.g., computing system 200, computing system 300, or the like) configured to receive and process data for operating the vehicle 402 in an environment. The vehicle 402 can include one or more operational systems 406 (e.g., mapping 232, motion estimation 234, perception and understanding 236, behaviors and planning 242, control 240, object detection and reference path generator 246, combinations thereof, or the like) for operating the vehicle 402 within the environment.

The vehicle 402 can include one or more sensors 408 (e.g., sensors 202) for detecting the environment and objects within the environment around the vehicle 402. The sensors 408 can include one or more of, e.g., cameras, radar, LiDAR, combinations thereof, or the like. Each of the sensors 408 includes a field-of-view which provide for maximum coverage and visibility around the vehicle 402. Although the data from the sensors 408 is generally sufficient for the vehicle 402 to safely move through an environment, in some instances, partial or complete obstructions of the field-of-view of one or more sensors 408 can occur due to various objects located in a complex environment. In some embodiments, if the sensors 408 are mounted on a vehicle 402, there may be limited visibility behind a trailer coupled to the vehicle 402. In some embodiments, the field-of-view of the sensors 408 may not be capable of detecting objects as the vehicle 402 approaches an intersection if the objects are obstructed by a building or another larger object. In such instances, the exemplary system 400 assists the vehicle 402 by supplementing the sensor 408 data to ensure accurate perception of the environment and operation of the vehicle 402 is achieved.

The vehicle 402 includes a user interface 410 (e.g., vehicle interface 204) configured to receive/transmit and display data for operation of the system 400, as well as the vehicle 402 itself. The vehicle 402 can include one or more databases 412 (e.g., memory 306) configured to receive and electronically store data. In some embodiments, the database 412 can be stored externally from the vehicle 402 and the vehicle 402 can be in communication with the external database 412 for receiving and/or transmitting data associated with the system 400. In some embodiments, the database 412 can be located at mission control 414 (or at any other external location proximate a control unit) external to the vehicle 402 and in communication with the vehicle 402. In some embodiments, the database 412 can be located on the vehicle 402 itself. In some embodiments, one or more portions of the database 412 can be distributed across components of the system 400. The database 414 can store information relating to data collected by one or more sensors regarding the vehicle 402 and/or the environment through which the vehicle 402 is traveling.

In particular, the system 400 includes one or more sensors 416 disposed in the environment through which the vehicle 402 is traveling. In some embodiments, the sensors 416 can be substantially the same as the sensors 408, e.g., cameras, radar, LiDAR, combinations thereof, or the like. In some embodiments, one or more of the sensors 416 can be different from the sensors 408. However, the data captured by the sensors 416 and the sensors 408 can be compatible such that the system 400 can compare and fuse the data as needed to ensure accurate perception data is provided to the vehicle 402.

The environment sensors 416 can be positioned anywhere in the environment to facilitate a large field-of-view of the environment and any vehicles 402 traveling through the environment. Thus, the environment sensors 416 can be used to detect details regarding the vehicle 402 itself, as well as surrounding objects. As a non-limiting example, the sensors 416 can be mounted to sides of buildings, rooftops, building corners, traffic lights, light poles, or the like. In general, the sensors 416 can be positioned at a higher elevation from the roadway to ensure a broader visibility of the environment (e.g., a bird's eye view). In some embodiments, the accuracy or precision level of the sensors 416 can be greater (and is at least equal to) the accuracy or perception level of the sensors 408 of the vehicle 402.

The sensors 416 capture data associated with the environment, and this data can be electronically stored in the database 412 as a first sensor data set 418. As an example, the data set 418 can include information regarding bounding boxes representing objects detected in the environment, as well as a bounding box for the vehicle 402. The bounding boxes can include associated information regarding the objects, such as the time of detection, the object type, the object size, the object velocity, the object position, the object acceleration, the object trajectory, or the like. This information can be electronically stored as detected object characteristics 420.

As the vehicle 402 travels through the environment, the vehicle sensors 408 similarly capture data regarding detected objects within the field-of-view of the vehicle sensors 408. This data can be electronically stored in the database 412 as a second sensor data set 422. The data from the vehicle sensors 408 can be used to generate bounding boxes representative of the detected objects, and the object characteristics from the vehicle sensors 408 can be stored in the detected object characteristics 420.

The processing device 404 of the vehicle 402 (or a central processing device, e.g., located at mission control 414) can receive as input both data sets 418, 422 and can compare the data to determine a matching level 424 between the data sets 418, 422. In some embodiments, the processing device 404 can determine if any overlapping object detection exists, e.g., the same object is detected by both sensors 408, 416, and if the object characteristics 420 from each of the sensors 408, 416 match. This can be referred to as “corresponding data”. For example, if both sensors 408, 416 detect another vehicle in the environment, the data sets 418, 422 are matched to determine if the object characteristics 420 sufficiently match relative to a matching threshold 426, or if an inconsistency 428 exists between the data sets 418, 422. In some embodiments, the matching threshold 426 can be a customized input value into the system 400, e.g., an 80-100% inclusive minimum match, an 85-100% inclusive minimum match, a 90-100% inclusive minimum match, a 95-100% inclusive minimum match, an 80% minimum match, an 85% minimum match, a 90% minimum match, a 95% minimum match, or the like.

In some embodiments, the system 400 can take into account the sensor 408, 416 uncertainties or characteristics when determining if a match or inconsistency exists. For example, if a radar sensor has a 1 meter standard deviation (σ) for position tracking, the system 400 can define a criteria using the standard deviation to identify the matching threshold 426. As a further example, the matching threshold 426 can be programmed as having an acceptable variance of 2σ for the radar sensor data and, if the radar sensor has the 1 meter standard deviation, any corresponding data within 2 meters (i.e., 2σ) would be considered as matching values. Any data outside of the 2 meter range would be considered as an inconsistency 428. Similar sensor 408, 416 characteristics and operating parameters can be taken into account for other types of sensors of the system 400, and can be independently determined based on the type of sensor and the respective operating parameters.

In some embodiments, if the minimum matching threshold 426 is met, the system 400 determines that no inconsistencies 428 exist and data from the vehicle sensors 408 does not need to be supplemented. For example, if both data sets 418, 422 identify a detected vehicle speed at 5 mph, the data set 422 can be used by the processing device 404 to operate the vehicle 402 through the environment and relative to the detected other vehicle. In some embodiments, even if the minimum matching threshold 426 is met, the system 400 can fuse the environment sensor 416 data with the vehicle sensor 408 data (e.g., fused sensor data 432) to create a larger data set for consideration by the processing device 404 when guiding the vehicle 402 through the environment. By using a greater data set with fused information, the system 400 ensures that the vehicle 402 safely travels through the environment.

If the minimum matching threshold 426 is not met, the system 400 identifies that an inconsistency 428 exists and data from the vehicle sensor 408 needs to either be supplemented or replaced entirely. The data from the data set 422 being replaced/supplemented and the data being used from the data set 418 being used as the replacement/supplemental data can be stored in the replaced/supplemented data 430 as a record. The data being used by the system 400 from the data sets 418, 422 is fused to generate the fused sensor data 432, which can be used by the processing device 404 to guide the vehicle 402 through the environment. For example, if the data set 418 shows detection of another vehicle traveling at 15 mph and the data set 422 shows detection of the same vehicle traveling at 5 mph, the data set 418 information can replace the data set 422 information to ensure accurate object information is begin used in the determination of how to operate the vehicle 402 through the environment.

In some embodiments, the processing device 404 can determine that there is no overlapping data or object detection for some of the data sets 418, 422, i.e., no corresponding data. For example, if the vehicle sensor 408 cannot detect another vehicle approaching an intersection and the environment sensors 416 (due to their higher position) detect the vehicle approaching the intersection, there is no overlapping data regarding the other vehicle. In such embodiments, the processing device 404 can determine that the matching threshold 426 has not been met (e.g., due to nonexistent or inadequate data from the vehicle sensor 408), and an inconsistency 428 is identified. In such embodiments, the data from the environment sensors 416 can be fused with the vehicle sensor 408 data to ensure that the vehicle 402 is aware of the other vehicle approaching the intersection. The processing device 404 can use the fused sensor data 432 to regulate operation of the vehicle 402 as it approaches the intersection to ensure a collision with the other vehicle is avoided.

In some embodiments, the system 400 can generate an alert 434 to the vehicle 402 (e.g., to the driver of the vehicle 402 via the user interface 410) regarding an inconsistency 428 and the other vehicle approaching the intersection. In some embodiments, the environment sensor 416 data may indicates detection of a moving object and the trajectory of the object is away from the intersection towards which the vehicle 402 is moving. Due to the trajectory of the object, the system 400 can determine that the detected object data does not need to be supplemented and provided to the processing device 404 for consideration, due to the anticipated trajectory of the detected object not crossing the planned path of the vehicle 402.

In some embodiments, the lack of overlapping data can be based on a lack of data from the environment sensors 416 as compared to the vehicle sensors 408. For example, the vehicle sensors 408 indicate detection of an object in the vicinity of the vehicle 402, while the environment sensors 416 fail to identify the object. In such embodiments, for safety purposes, the system 400 can rely on the vehicle sensor 408 data and can operate the vehicle 402 with the assumption that the detected object is indeed located in the environment and should be avoided.

Therefore, if inconsistencies 428 in the data sets 418, 422 are detected, the environment sensor 416 data is generally used to supplement or replace the vehicle sensor 408 data based on the expectation that the environment sensor 416 data has a higher accuracy due to positioning of the sensors 416 and the overall higher perception quality of the sensors 416. Thus, in some embodiments, the system 400 can assign higher priority or weight to the environment sensor 416 data if inconsistencies 428 are detected with the vehicle sensor 408 data. In some embodiments, the distance of the environment sensors 416 relative to the detected object for which an inconsistency exists can be considered by the system 400 when determining priority or weighing of data.

For example, if the environment sensors 416 are located a distance from the detected object that is further than a distance threshold relative to the detected object, and the vehicle sensors 408 are closer to the detected object, the system 400 can assign higher priority to the vehicle sensor 408 data. The distance threshold can be determined based on the sensor 416 type and operating characteristics. Radar sensors can have a range of about 100 m, while LiDAR can have a range of up to 300 m, for example. As the distance of the sensor 416 relative to the detected object (and/or the vehicle 402) approaches the range limit, the accuracy of the sensor 416 data can be reduced and higher priority can be given to the vehicle sensor 408 data.

In some embodiments, the weighing of the sensor 408, 416 data can be adjusted based on the distance of the sensor 408, 416 relative to a target detected object. In some embodiments, the closer the sensor 408, 416 is to the target detected object, the higher the weight applied by the system 400 to the sensor 408, 416 data. For example, if the environment sensor 416 is within 100 m of the target object and the vehicle sensor 408 is 300 m away from the target object, the environment sensor 416 is considered to be more accurate and is given higher priority or weight relative to the vehicle sensor 408 data.

In some embodiments, prioritization of the sensor 408, 416 data can be determined based on the operating status of the respective sensors 408, 416. The operating status can include, e.g., polluted sensors, malfunction of the sensor, low visibility, combinations thereof, or the like. A polluted sensor can include an obstructed of the field-of-view due to, e.g., water droplets, moisture, dust, dirt, combinations thereof, or the like, on the sensor. A malfunction of the sensor can result in an improper signal or no signal at all transmitted to the processing device. Low visibility of the sensor can be due to, e.g., fog, rain, snow, or the like. Such low visibility can affect both sensors 408, 416, but the environment sensor 416 may define a larger field-of-view that provides for improved visibility of the environment as compared to the vehicle sensor 408. In some embodiments, if the sensor 416 field-of-view is partially obstructed (e.g., by the vehicle 402 or other objects), the data from the vehicle sensor 408 can be used as priority over the environment sensor 416 data due to the obstructed nature of the environment sensor 416.

In some embodiments, the inconsistencies 428 can include the detection of objects of different classes (e.g., vehicle vs. pedestrian), occluded objects that appear in one data set 418 and not in the other data set 422, differences in position, velocity and/or shape of the detected objects in the data sets 418, 422, combinations thereof, or the like. In autonomous and semi-autonomous vehicles 402, the confidence of a tracked object can generally be determined based on fused sensor information using techniques that integrate data from multiple sensors 408, such as cameras, radar, LiDAR, ultrasonic sensors, combinations thereof, or the like. Such fusion enhances the reliability and robustness of object tracking. The confidence of an object typically reflects the system's certainty about the object's presence, position, velocity, and classification, and this confidence determination can be used to indicate whether an inconsistency 428 is detected. The steps taken for the confidence determination are discussed below.

Initially, sensor fusion is performed by integrating multimodal data sensor measurement models. Each sensor (e.g., sensors 408, 416) provides its own measurement data, often with associated uncertainties. For example, cameras provide high-resolution images, but may be sensitive to certain lighting and/or weather conditions. Radar offers accurate range and velocity data, but may have lower resolution that cameras. LiDAR delivers precise distance and three-dimensional (3D) shape information, but may struggle with reflective or transparent objects. A fusion algorithm (e.g., Kalman Filter (KF), or the like) can therefore be executed by the processing device 404 to combine the sensor data (e.g., data sets 418, 422).

Confidence value computational steps with data association can be performed by the processing device 404. The processing device 404 can match sensor observations with existing tracked objects. The system 400 can assign scores based on spatial proximity, velocity similarity, and object features (e.g., shape or size). The system 400 can weigh by reliability the sensor data. In particular, each sensor's input can be weighted based on the sensor reliability and current environmental conditions. For example, radar may be weighted higher in poor visibility conditions. As a further example, cameras may dominate under good lighting conditions.

The system 400 is also capable of handling uncertainty propagation. The system 400 fuses sensor uncertainties (often modeled as covariance matrices) to determine the overall uncertainty of the tracked object's state. The system 400 validates the consistency of the object's state (position, velocity, or the like) over time using temporal filters. The confidence value increases if observations from multiple sensors consistently align over successive frames. The system 400 also takes into account the classification confidence value. If classification (e.g., vehicle, pedestrian, bicycle, or the like) is required, the sensor data can be analyzed to assign a probability score to each class. Fusion of the sensor data can boost classification confidence by cross-verifying data across sensors from the vehicle 402 and the environment.

Certain key factors can affect the confidence sensor redundancy. More overlapping sensors (e.g., overlapping fields-of-view) can increase confidence in the detected data and object identification. Environmental conditions can affect confidence values, with adverse conditions (e.g., fog, rain, or glare) reducing confidence in the detected objects. Object dynamics can affect the confidence determination, with erratic or high-speed objects reducing tracking stability. Occlusion and overlap can affect the confidence value, with confidence decreasing if an object is partially or fully occluded. Measurement noise can affect confidence determinations, with higher noise leading to lower confidence. Sensor calibration can affect confidence determinations, with properly calibrated sensors contributing to higher confidence.

The system 400 can use confidence metric probability scores (e.g., matching thresholds 426) in determining how the sensor data should be treated. The confidence metric probability score can represent the likelihood of the object being present. The covariance ellipse can represents positional and/or velocity uncertainty (e.g., a smaller ellipse indicating higher confidence). The classification probabilities can represent the likelihood of the detected object belonging to specific categories (e.g., 90% car, 10% pedestrian). In some embodiments, the confidence metric probability score can be representative of the position and/or localization confidence, with a bounding box used to determine uncertainly. In some embodiments, a 2×2 or a 3×3 covariance matrix can be used to capture uncertainly in the x, y and (sometimes) z coordinates. Higher variance in x/y can mean more uncertainty in position estimation.

In some embodiments, the confidence metric probability score can be representative of the global positioning system (GPS) and/or the inertial measurement unit (IMU) confidence. Confidence in the GPS and/or IMU-based localization can be given in meters with a probability (e.g., 95% confidence within 0.2 m, or the like). In some embodiments, the confidence metric probability score can be representative of the temporal stability metrics. For example, consistency over time can be used for objects that should maintain relatively stable sizes and positions between frames. As a further example, an identity consistency score can be used to check how often an object maintains the same identification across multiple frames, thereby avoiding identification swaps in tracking.

The confidence score determined by the system 400 can guide decisions for operating the vehicle, such as braking, lane changes, and collision avoidance. In some embodiments, the system 400 can be used as a fail-safe mechanisms. For example, low-confidence detections can trigger additional sensor scans, alert human drivers, and/or reduce an automation level for the vehicle 402. By combining and fusing sensor data from the vehicle sensor 408 and the environment sensor 416, and continuously updating the tracked object's state and confidence, the system 400 can output more accurate and reliable decisions for operation of the vehicle 402, ensuring safety and efficiency even in complex environments.

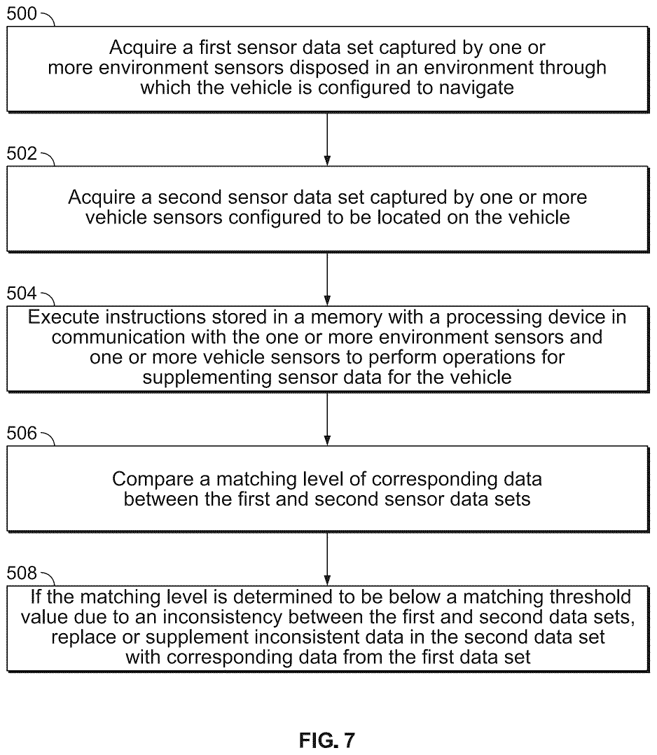

FIG. 7 is a flowchart of a method of supplementing sensor data for a vehicle by the exemplary system 400 discussed herein. At 500, the system acquires a first sensor data set captured by one or more environment sensors disposed in an environment through which the vehicle is configured to navigate. At 502, the system acquires a second sensor data set captured by one or more vehicle sensors configured to be located on the vehicle. At 504, instructions stored in a memory are executed with a processing device in communication with the one or more environment sensors and the one or more vehicle sensors to perform operations for supplementing sensor data for the vehicle. At 506, a matching level of corresponding data between the first and second sensor data sets is compared. At 508, if the matching level is determined to be below a matching threshold value due to an inconsistency between the first and second data sets, the inconsistent data in the second data set is replaced or supplemented with corresponding data from the first data set.

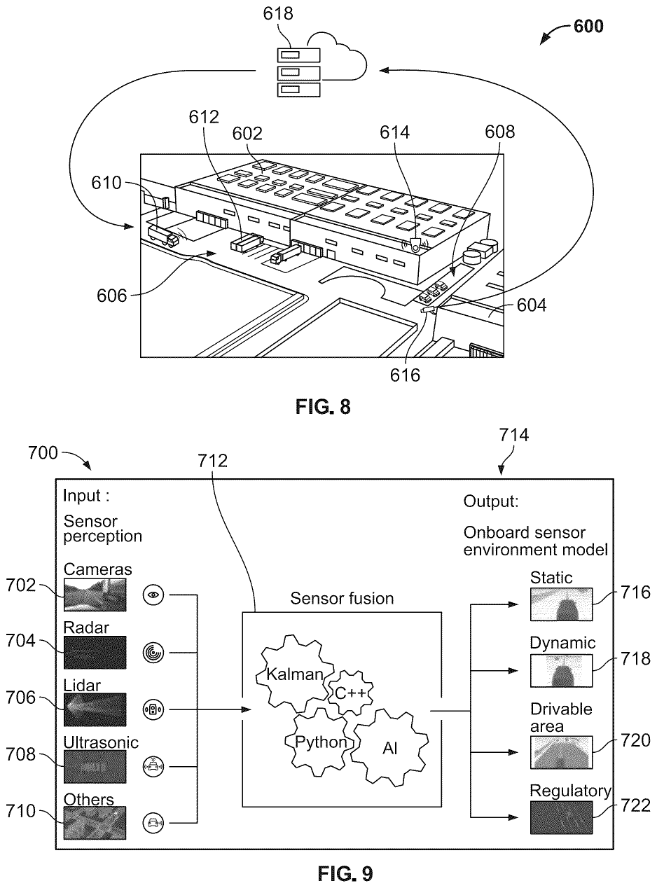

FIG. 8 is an environment 600 including the exemplary system 400. In particular, the environment 600 includes multiple buildings 602, 604 separated by roads 606, 608 that intersect. The vehicle 610 includes sensors for perception of the environment 600 and objects within the environment 600. However, in some instances, the field-of-view of the sensors of the vehicle 610 may be at least partially obstructed, preventing confident perception of the environment 600 by the vehicle 610. For example, a trailer 612 of another vehicle may block the field-of-view of the vehicle 610 sensors, preventing visibility of the road 606 ahead of the vehicle 610.

The exemplary system includes one or more sensors 614, 616 disposed in the environment 600 to supplement the sensor data from the vehicle 610. In some embodiments, the sensors 614, 616 can include, e.g., cameras, LiDAR, radar, or the like. As shown in FIG. 8, the sensors 614, 616 can be disposed at corners of the respective buildings 602, 604, thereby providing a bird's eye view of the environment 600 and the roads 606, 608. The field-of-view of the sensors 614, 616 is greater than the field-of-view of the vehicle 610 sensor due to the position of the sensors 614, 616. As such, the sensors 614, 616 are capable of gathering data on objects in the environment 600 which the vehicle 610 sensor may be incapable of fully and/or accurately visualizing.

In operation, the sensors of the vehicle 610 gather data regarding the environment 600 and objects in the environment 600. The sensors 614, 616 simultaneously gather data regarding the environment 600 and objects in the environment 600. Data from the sensors 614, 616 can be transmitted to a central server or processing unit 618 (e.g., at mission control), or can be directly transmitted to the vehicle 610. The data from the sensors 614, 616 and the vehicle 610 sensors can be compared to determine if any corresponding data exists, i.e., data that detects and identifies the same objects. If such corresponding data exists, the processing unit 618 (or a processing device of the vehicle 610) compares the data to determine if inconsistencies exist between the object identification details provided by the vehicle 610 sensors and those from the sensors 614, 616.

If an inconsistency exists, the data from the environment sensors 614, 616 can be used to either replace or supplement the conflicting data from the vehicle 610 sensor to ensure perception accuracy. If there is no corresponding data regarding some detected objects, e.g., the sensors 614, 616 have identified objects which the vehicle 610 sensor was incapable of detecting due to obstructions of the field-of-view of the vehicle 610 sensor, this data can be provided to the vehicle 610 for decision-making in operation within the environment 600. The vehicle 610 can thereby receive additional data from the sensors 614, 616 in the environment to provide a more robust data set and object list for accurate perception within the environment 600, resulting in safer operation of the vehicle 610.

FIG. 9 is a block diagram illustrating various inputs 700 of sensor data from both vehicle and environment sensors for fusion. In particular, sensor perception data from multiple sources is provided as the input 700 to the system. As an example, the inputs 700 include, e.g., vehicle cameras 702, vehicle radar 704, vehicle LiDAR 706, vehicle ultrasonic 708, environment cameras 710, or the like. The inputs 700 are transmitted to a fusion unit 712 which processes the data to determine if inconsistencies between the vehicle sensor and the environment sensor data exist. If inconsistencies are detected, the fusion unit 712 replaces or supplements the vehicle sensor data with the environment sensor data to ensure accuracy of information being used by the vehicle in determining movement through an environment.

The system ensures that any irregularities in the vehicle sensor data are replaced with more accurate environment sensor data, and provides the vehicle with additional data captured by environment sensors which was not captured by the vehicle sensors. The fused sensor data is transmitted to the vehicle (or a processing device of the vehicle), and the data is processed to generate various outputs 714 for guiding the vehicle through the environment, e.g., a static vehicle model 716, a dynamic vehicle model 718, a drivable area model 720, a regulatory model 722, or the like. The outputs 714 provide the vehicle with information regarding the environment and objects in the environment, and allow the vehicle to generate a travel path to safety move through the environment.

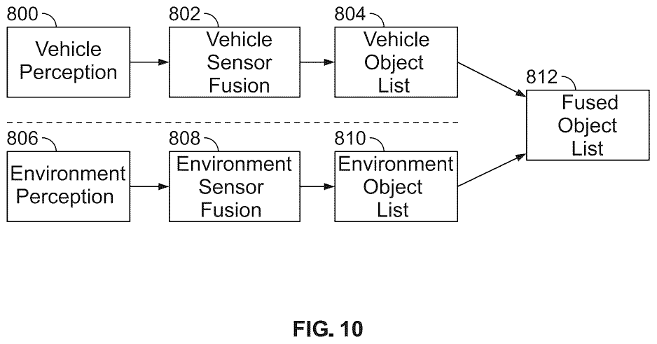

FIG. 10 is a flowchart illustrating fusion of vehicle and environment sensor data for generation of a fused object list. At 800, sensors of the vehicle capture data around the vehicle to detect objects and other characteristics associated with the environment through which the vehicle is traveling, as well as details regarding the vehicle itself. The vehicle sensor data can include data from the same or different types of sensors, e.g., cameras, radar, LiDAR, ultrasonic, or the like. At 802, the different sensor data captured by the vehicle sensors is fused and analyzed to determine object identification. At 804, based on the fused sensor data, a detected object list is generated and includes details regarding the detected objects in the environment, e.g., size, type, velocity, acceleration, trajectory, or the like.

At 806, sensors of the environment capture data to detect objects and other characteristics associated with the environment, including the vehicle traveling through the environment. The environment sensors can capture different types of data by using different types of sensors, similar to the vehicle. At 808, the different sensor data captured by the environment sensors is fused and analyzed to determined object identification. At 810, based on the fused sensor data, a detected object list is generated and includes details regarding detected objects in the environment, including details regarding the vehicle traveling through the environment.

At 812, the system combines the vehicle and environment object lists 804, 810 and analyzes/compares the data to determine if inconsistencies exist. For example, the vehicle object list 804 can identify objects A, B and C, while the environment object list 810 can identify objects A, B, C and D. The lack of object D in the vehicle object list 804 is marked as an inconsistency, and the vehicle object list 804 is supplemented with the environment object list 810 to ensure that details regarding object D are considered by the vehicle when determining its movement through the environment. The system also determines if the object characteristics for each of objects A, B and C match between the object lists 804, 810. For example, if the object A data from the vehicle object list 804 does not match the object A data from the environment object list 810, the environment object list 810 can replace the vehicle object list 804 for object A to ensure accuracy in object perception. In some embodiments, the system can provide greater weight to data taken from the sensor located closest to the target object, particularly if an inconsistency is detected. If both the vehicle and environment sensors are located a substantially equal distance from the target object (and there is no indication of sensor malfunction, pollution and/or obstruction), the environment sensor can be given higher priority or weight. However, a combination of the vehicle and environment sensor data can be used to ensure that the vehicle operation and travel path is based on a greater amount of data (e.g., not only the vehicle sensor data). By relying on the fused object list, the exemplary system ensures that the vehicle relies on a robust and accurate data set for generating a travel path for the vehicle through the environment.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A system for supplementing sensor data for a vehicle, the system comprising:
one or more environment sensors disposed in an environment through which the vehicle is configured to navigate, wherein the one or more environment sensors are configured to capture a first sensor data set;
one or more vehicle sensors configured to be located on the vehicle, wherein the one or more vehicle sensors are configured to capture a second sensor data set; and
a processing device in communication with the one or more environment sensors and the one or more vehicle sensors, wherein the processing device is configured to execute instructions stored in a memory to perform operations comprising:
acquiring the first sensor data set from the one or more environment sensors;
acquiring the second sensor data set from the one or more vehicle sensors;
comparing a matching level of corresponding data between the first and second sensor data sets; and
if the matching level is determined to be below a matching threshold value due to an inconsistency between the first and second data sets, replacing or supplementing inconsistent data in the second data set with corresponding data from the first data set.

2. The system of claim 1, wherein the one or more vehicle sensors and the one or more environment sensors include at least one of a camera, radar, or LiDAR.

3. The system of claim 1, wherein the one or more environment sensors are different from the one or more vehicle sensors.

4. The system of claim 1, wherein the one or more environment sensors have a higher detection accuracy than the one or more vehicle sensors.

5. The system of claim 1, wherein the first and second sensor data sets relate to detected characteristics associated with the vehicle.

6. The system of claim 1, wherein the first and second sensor data sets relate to detected characteristics associated with the environment.

7. The system of claim 1, wherein at least a portion of the first sensor data set includes information representative of detected characteristics out of a field-of-view of the one or more vehicle sensors.

8. The system of claim 1, wherein at least a portion of the first sensor data set includes information representative of detected characteristics in an obstructed area of a field-of-view of the one or more vehicle sensors.

9. The system of claim 7, wherein the detected characteristics include a moving object.

10. The system of claim 9, wherein the operations include determining, with the one or more environment sensors, a velocity and trajectory of the moving object.

11. The system of claim 10, wherein the operations include determining if the moving object is on course for a collision with the vehicle.

12. The system of claim 11, wherein if the moving object is on course for a collision with the vehicle, the operations include transmitting an alert to the vehicle regarding the moving object.

13. The system of claim 1, wherein the inconsistency includes a lack of matching data between the first and second data sets.

14. The system of claim 1, wherein the inconsistency includes a lack of the corresponding data between the first and second data sets.

15. The system of claim 1, wherein the one or more environment sensors are stationary mounted sensors.

16. The system of claim 1, wherein the vehicle is an autonomous vehicle.

17. The system of claim 1, wherein the vehicle is a semi-autonomous vehicle or a non-autonomous vehicle.

18. A computer-implemented method for supplementing sensor data for a vehicle, the computer-implemented method comprising:
acquiring a first sensor data set captured by one or more environment sensors disposed in an environment through which the vehicle is configured to navigate;
acquiring a second sensor data set captured by one or more vehicle sensors configured to be located on the vehicle; and
executing instructions stored in a memory with a processing device in communication with the one or more environment sensors and one or more vehicle sensors to perform operations comprising:
comparing a matching level of corresponding data between the first and second sensor data sets; and
if the matching level is determined to be below a matching threshold value due to an inconsistency between the first and second data sets, replacing or supplementing inconsistent data in the second data set with corresponding data from the first data set.

19. The method of claim 18, wherein at least a portion of the first sensor data set includes information representative of detected characteristics out of a field-of-view of the one or more vehicle sensors.

20. The method of claim 18, wherein at least a portion of the first sensor data set includes information representative of detected characteristics in an obstructed area of a field-of-view of the one or more vehicle sensors, and wherein the operations include determining, with the one or more environment sensors, a velocity and trajectory of the moving object to determine if the moving object is on course for a collision with the vehicle.
